(19) United States
(12) Patent Application Publication
(10) Pub. No.: US 2011/0094042 A1
(43) Pub. Date: Apr. 28, 2011

(54) WIRE GUIDER AND A DRILL USING THE SAME

(76) Inventor: SHU-RU LI, Taichung City (TW)

(21) Appl. No.: 12/607,020

(22) Filed: Oct. 27, 2009

(51) Int. Cl. B23B 47/00; B65H 57/00; B65H 57/12

(52) U.S. Cl. 7/158; 242/615.3

(57) ABSTRACT

A wire guider of the present invention includes a head portion, a flexible string unit and a sleeve. The string element includes a first string unit and a second string unit, each of which has a first end, a second end and a middle string segment connecting the first and second ends. The first ends of the string units are disposed on the head portion. The second end of the first string unit is slidably disposed on the middle string segment of the first string unit to define a first circle, and the second end of the second string unit passes through the first circle and then is slidable disposed on the middle string segment of the second string unit to define a second circle. The sleeve can surround a part of the string units. As such, the circles are adapted to lock a wire.

### BACKGROUND OF THE INVENTION

1. Field of the Invention

The present invention relates to a wire guider, and more particularly to a wire guider that can guide a wire through a bore.

2. Description of the Prior Art

The installation of the wire layout is very common in a construction, and it includes boring a hole on the wall, and then installing the wire through the hole. Sometimes the wire is too soft to successfully pass through the hole, thus an auxiliary guiding device would come in very useful.

### SUMMARY OF THE INVENTION

The main object of the present invention is to provide a wire guider to guide the wire through a bore easily.

To achieve the above and other objects, a wire guider of the present invention includes a head portion, a flexible string element and a sleeve. The string element includes a first string unit and a second string unit, each of which has a first end, a second end and a middle string segment connecting the first and second ends. The first ends of the string units are disposed on the head portion. The second end of the first string unit is slidably disposed on the middle string segment of the first string unit to define a first circle, and the second end of the second string unit passes through the first circle and then is slidable disposed on the middle string segment of the second string unit to define a second circle. The sleeve can surround a part of the string units. As such, the circles are adapted to lock a wire and guide it through a bore.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a drawing showing a drill using a wire guider of the present invention;

FIG. 2 is a perspective drawing showing a wire guider of the present invention;

FIG. 3 is a profile showing a wire guider of the present invention;

FIG. 4 is a profile showing a wire guider of the present invention locking a wire.

### DETAILED DESCRIPTION OF THE PREFERRED EMBODIMENTS

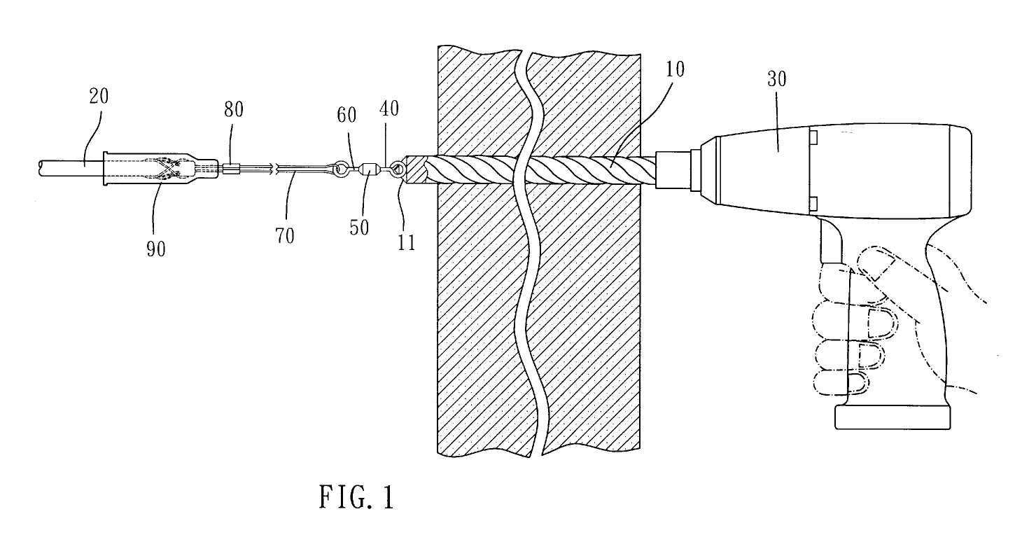

Please refer to FIG. 1. A wire guider of the present invention can be installed on a distal end of a drill head 10, in which the drill head 10 has a through hole 11 for the wire guider to fix thereto. When a hole is bored by the drill 30, the wire guider along with a wire 20 can be fixed to the drill head 10. Thereafter, the drill head 10 is drawn from the hole, and the wire guider guides the wire 20 through the bore at the same time.

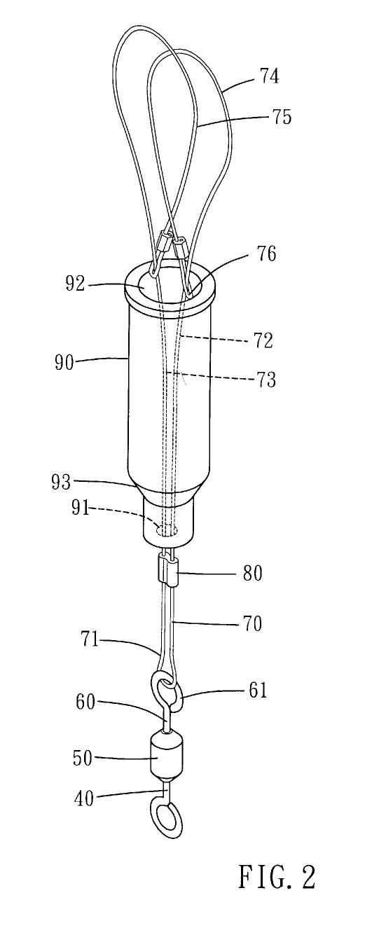

Please refer to FIG. 1 and FIG. 2. The wire guider of the present invention includes a connecting unit 40, a jointer 50, a head portion 60, a flexible string element 70 and a sleeve 90. The connecting unit 40 is hooked in the through hole 11 to fix the wire guider to the drill head 10. The jointer 50 connects the head portion 60 to the connecting unit 40, and the head portion 60 is rotatable about the connecting unit 40. More specifically, at least one of the connecting unit 40 and the head portion 60 is rotatable about the jointer 50. The head portion 60 is formed with a hook 61 for the string element 70 to pass therethrough. The string element 70 includes a first string unit 72 and a second string unit 73. Each string unit has a first end 71, a second end 76 and a middle string segment connecting the first and second ends 71 and 76. The first ends 71 of the string units 72 and 73 are disposed on the head portion 60. Preferably, the first ends 71 integrally connect to each other, i.e. the string element 70 simply consists of a single string as shown in the present embodiment. Or, the string element 70 may also consist of two separate strings, thus the first ends of the separate strings are affixed to the head portion 60 individually. The second end of the first string unit 72 is slidably disposed on the middle string segment of the first string unit 72 to define a first circle 74, and the second end of the second string unit 73, on the other hand, passes through the first circle 74 first and then is slidably disposed on the middle string segment of the second string unit 73 to define a second circle 75. That is, the first circle 74 and the second circle 75 cross each other, and the dimension of the circles 74 and 75 is adjustable.

A fixation point is defined between each circle and its corresponding first end, and the fixation unit 80 fixes the fixation points so that the length of the first string element 72 and the second string element 73 is fixed. The sleeve 90 may be made of a rubber material or the like so that the sleeve 90 is tube-shaped with elasticity. The sleeve 90 has a receiving space, a first opening 91 and a second opening 92. Both the openings 91 and 92 communicate with the receiving space, while the first opening 91 is smaller than the second opening 92. Preferably, a part of the sleeve 90 is a tapered section 93. The string units 72 and 73 are mainly received in the receiving space. The first ends extend beyond the first opening 91, and the circles 74 and 75 extend beyond the second opening 92.

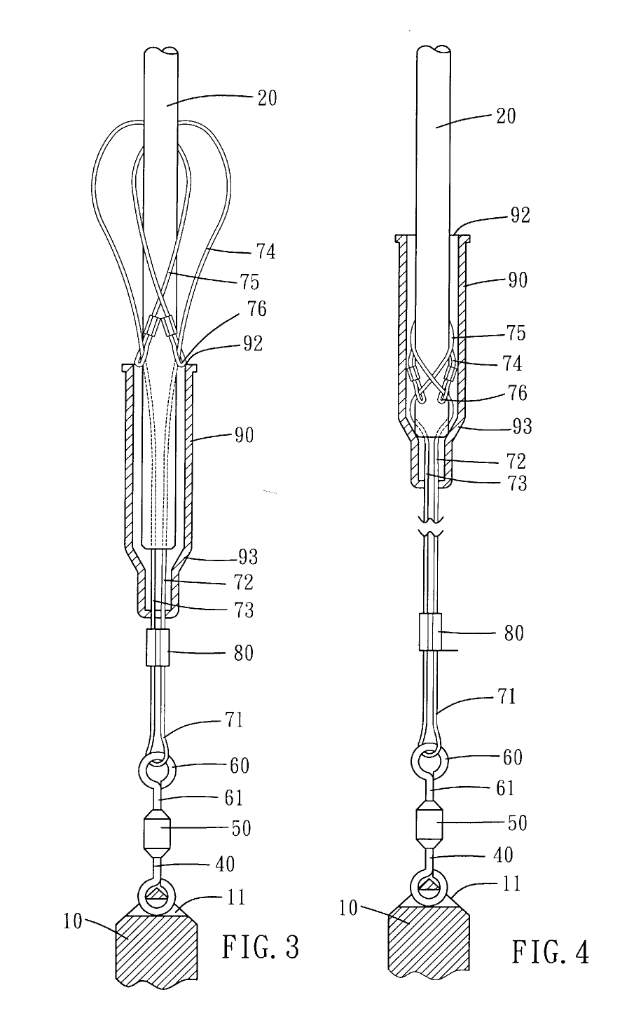

Next, please refer to FIG. 3 and FIG. 4. A distal end of the wire 20 is inserted through the circles 74 and 75, and the wire 20 is then inserted into the receiving space from the second opening 92. Thereafter, the user can push the sleeve 90 toward the wire 20 while pulling the middle string segments or the fixation unit 80 backward so as to narrow the circles 74 and 75. As such, the circles 74 and 75 tightly surround and lock the wire 20. Therefore, the drill head 10 can be drawn from a bore and pulls the wire 20 through the bore at the same time. When the wire 20 is to be released, the user can simply pull the sleeve 90 away from the wire 20 and loosen the circles 74 and 75, thus the wire 20 can be drawn from the sleeve 90 and the circles 74 and 75 effortlessly.

What is claimed is:

1. A wire guider, comprising:
a head portion;
a flexible string element, comprising a first string unit and a second string unit, each of the string units having a first end, a second end and a middle string segment connecting the first and second ends, the first ends of the string units being disposed on the head portion, the second end of the first string unit being slidably disposed on the middle string segment of the first string unit to define a first circle, the second end of the second string unit passing through the first circle and then being slidably disposed on the middle string segment of the second string unit to define a second circle, the first circle and the second circle crossing each other;
a sleeve, surrounding a part of the string units.

2. The wire guider of claim 1, wherein the sleeve is tube-shaped, and the sleeve has a receiving space, a first opening and a second opening, both the openings communicate with the receiving space, the first opening is smaller than the second opening, the string units is mainly received in the receiving space, the first ends extend beyond the first opening, and the circles extend beyond the second opening.

3. The wire guider of claim 2, wherein at least a part of the sleeve is tapered.

4. The wire guider of claim 1, wherein the sleeve is elastic.

5. The wire guider of claim 1, further comprising a jointer and a connecting unit, the jointer connecting the head portion to the connecting unit, the head portion being rotatable about the connecting unit.

6. The wire guider of claim 1, further comprising a fixation unit, a fixation point being defined between each circle and its corresponding first end, the fixation unit fixing the fixation points.

7. The wire guider of claim 1, wherein the first ends being affixed to the head portion.

8. The wire guider of claim 1, wherein the first ends integrally connect to each other.

9. A drill, comprising:
a drill head, having a through hole at its distal end;
a wire guider, comprising:
a head portion;
a flexible string element, comprising a first string unit and a second string unit, each of the string units having a first end, a second end and a middle string segment connecting the first and second ends, the first ends of the string units being disposed on the head portion, the second end of the first string unit being slidably disposed on the middle string segment of the first string unit to define a first circle, the second end of the second string unit passing through the first circle and then being slidably disposed on the middle string segment of the second string unit to define a second circle, the first circle and the second circle crossing each other;
a sleeve, surrounding a part of the string units;
a connecting unit, hooked in the through hole; and
a jointer, connecting the head portion to the connecting unit, the head portion being rotatable about the connecting unit;
wherein the first ends being affixed to the head portion.

10. A drill, comprising:
a drill head, having a through hole at its distal end;
a wire guider, comprising:
a head portion;
a flexible string element, comprising a first string unit and a second string unit, each of the string units having a first end, a second end and a middle string segment connecting the first and second ends, the first ends of the string units being disposed on the head portion, the second end of the first string unit being slidably disposed on the middle string segment of the first string unit to define a first circle, the second end of the second string unit passing through the first circle and then being slidably disposed on the middle string segment of the second string unit to define a second circle, the first circle and the second circle crossing each other;
a sleeve, surrounding a part of the string units;
a connecting unit, hooked in the through hole; and
a jointer, connecting the head portion to the connecting unit, the head portion being rotatable about the connecting unit;
wherein the first ends integrally connect to each other.
